(19) United States
(12) Patent Application Publication
(10) Pub. No.: US 2021/0256728 A1
(43) Pub. Date: Aug. 19, 2021

(54) OBJECT DETECTION APPARATUS

(71) Applicant: DENSO CORPORATION, Kariya-city (JP)

(72) Inventors: Masakazu IKEDA, Nisshin-city (JP); Mitsutoshi MORINAGA, Kariya-city (JP)

(21) Appl. No.: 17/313,626

(22) Filed: May 6, 2021

Related U.S. Application Data
(63) Continuation of application No. PCT/JP2019/042829, filed on Oct. 31, 2019.

(30) Foreign Application Priority Data
Nov. 9, 2018 (JP) 2018-211484

(51) Int. Cl. G06T 7/70; G06T 7/254; G01S 13/58; G01S 13/89

(52) U.S. Cl. CPC G06T 7/70; G06T 7/254; G06T 2207/10044; G01S 13/89; G01S 13/58

(57) ABSTRACT

In an object detection apparatus for detecting a position of an object based on at least measured distances to the object as measurement results by a plurality of ranging sensors, a speed difference calculator calculates, for each of candidate points representing the position of the object, a relative speed difference between the relative speeds of the candidate point acquired from the plurality of ranging sensors. The candidate-point determiner determines that a candidate point of the candidate points, the relative speed difference of which is equal to or greater than a predetermined value, is a virtual image of the object. An object detector detects the position of the object based on positions of the candidate points each determined to be a real image after removal of the candidate points each determined to be a virtual image from all of the candidate points.

### CROSS-REFERENCE TO RELATED APPLICATION

This international application claims the benefit of priority from Japanese Patent Application No. 2018-211484 filed with the Japan Patent Office on Nov. 9, 2018, the entire contents of which are incorporated herein by reference.

### BACKGROUND

### Technical Field

This disclosure relates to a position of an object using a plurality of ranging sensors.

### Related Art

A known technique for detecting a position of an object using a plurality of sensors includes measuring, for each of two pairs of sensors of three or more sensors, a time-of-arrival difference between radio waves from an object, and detecting a position of the object based on the fact that the time-of-arrival difference for each pair of sensors arises from a difference between distances from the object to the sensors of the pair.

When detecting the position of the object based on the time-of-arrival differences measured by the respective pairs of sensors, a plurality of different time-of-arrival differences may be measured by each pair of sensors due to interference between signals or noise generated in a receiver including the sensors.

In cases where a plurality of different time-of-arrival differences are measured by each pair of sensors, the known technique shifts, for each pair of sensors, the radio wave signal received by the sensor other than the reference sensor by the respective time-of-arrival differences and calculates an inner product of the radio wave signal received by the reference sensor and each of shifted signals for the other sensor.

Shifting the radio wave signals having correct time-of-arrival differences, received by the other sensors of the respective pairs of sensors, by these correct time-of-arrival differences will provide radio wave signals having the same arrival time for the respective pairs of sensors. Values of inner products of these shifted radio wave signals are greater than values of inner products of the other radio wave signals shifted by incorrect time-of-arrival differences.

The above known technique is configured to detect an object based on the time-of-arrival differences for respective pairs of highly correlated radio wave signals having a large inner product value.

It is known that a distance to an object is measured by each of a plurality of ranging sensors and intersections of circles centered at the respective ranging sensors, each with a radius equal to the measured distance to the object, are detected as a position of the object.

### BRIEF DESCRIPTION OF THE DRAWINGS

In the accompanying drawings:

FIG. 1 is a block diagram of an object detection apparatus according to a first embodiment;

FIG. 2 is an illustration of extracting candidate points based on measured distances;

FIG. 3 an illustration of an object detection process based on measured distances;

FIG. 4 is a block diagram of an object detection apparatus according to a second embodiment;

FIG. 5 is an illustration of calculation of a speed and a movement direction of an object from measured distances and relative speeds;

FIG. 6 is an illustration of surroundings of a vehicle;

FIG. 7 is an illustration of candidate points extracted based on measured distances; and

FIG. 8 is an illustration of a result of object detection.

### DESCRIPTION OF SPECIFIC EMBODIMENTS

As a result of detailed research performed by the present inventors, an issue was found that the known technique, as disclosed in JP-A-2014-44160, needs calculation of inner products between all the pairs of radio wave signals received by the respective pairs of ranging sensors to acquire pairs of highly correlated radio wave signals, which leads to a large processing load.

In addition, one more issue was found that, when extracting intersections of circles, each with a radius equal to the distance to the object, as candidate points representing a position of the object and performing a detection process on these extracted candidate points, performing the detection process on all the candidate points also leads to a large processing load.

In view of the foregoing, it is desired to have a technique for detecting an object with as little processing load as possible based on candidate points of the object extracted based on distances to the object measured by ranging sensors.

One aspect of this disclosure provides an object detection apparatus for detecting a position of an object based on at least measured distances to the object as measurement results of a plurality of ranging sensors, includes a result acquirer, a candidate-point extractor, a candidate-point determiner, and an object detector.

The result acquirer is configured to acquire the measurement results from the plurality of ranging sensors. The candidate-point extractor is configured to extract candidate points representing the position of the object based on the measured distances to the object as the measurement results acquired by the result acquirer.

The candidate-point determiner is configured to determine, for each of the candidate points extracted by the candidate-point extractor, whether the candidate point is a real image or a virtual image of the object. The object detector is configured to detect the position of the object based on positions of the candidate points each determined by the candidate-point determiner to be a real image after removal of the candidate points each determined by the candidate-point determiner to be a virtual image from the candidate points.

With this configuration, candidate points of an object are extracted based on measure distances to the object measured by a plurality of ranging sensors and virtual images of the object are removed from the candidate points, which enables removal of candidate points representing the virtual images from the candidate points on which an object detection process is to be performed. This enables detection of the position of the object with as little processing load as possible based on positions of the candidate points of real images after removal of the candidate points of virtual images.

Hereinafter, some embodiments of the disclosure will be described with reference to the drawings.

### 1. FIRST EMBODIMENT

1-1. Configuration

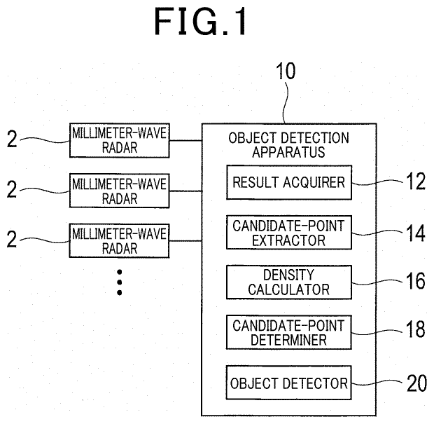

The object detection apparatus 10 illustrated in FIG. 1 is mounted to a mobile object, such as a vehicle or the like, and detects a position of an object present around the mobile object. The object detection apparatus 10 acquires, from each of a plurality of millimeter-wave radars 2, a distance information between the object and the millimeter-wave radar 2. FIG. 1 illustrates three or more millimeter-wave radars 2 mounted to a vehicle.

The object detection apparatus 10 is configured around at least one microcomputer formed of a central processing unit (CPU), a semiconductor memory, such as a read-only memory (ROM), a random-access memory (RAM), a flash memory and the like, and an input-output interface, In the following, the semiconductor memory will merely be referred to as a memory. The object detection apparatus 10 may include a single microcomputer or may include a plurality of microcomputers.

Various functions of the object detection apparatus 10 may be implemented by the CPU executing a program stored in a non-transitory computer readable storage medium. In this example, the memory corresponds to the non-transitory computer readable storage medium storing the program. A method corresponding to the program may be performed by the CPU executing this program.

The object detection apparatus 10 includes, as functional blocks implemented by the CPU executing the program, a result acquirer 12, a candidate-point extractor 14, a density calculator 16, a candidate-point determiner 18, and an object detector 20.

A technique for implementing these functions constituting the object detection apparatus 10 is not limited to software, but some or all of the functions may be implemented using one or more pieces of hardware. For example, in a case where these functions are implemented by an electronic circuit which is hardware, the electronic circuit may be implemented by a digital circuit including a number of logic circuits, an analog circuit, or a combination thereof.

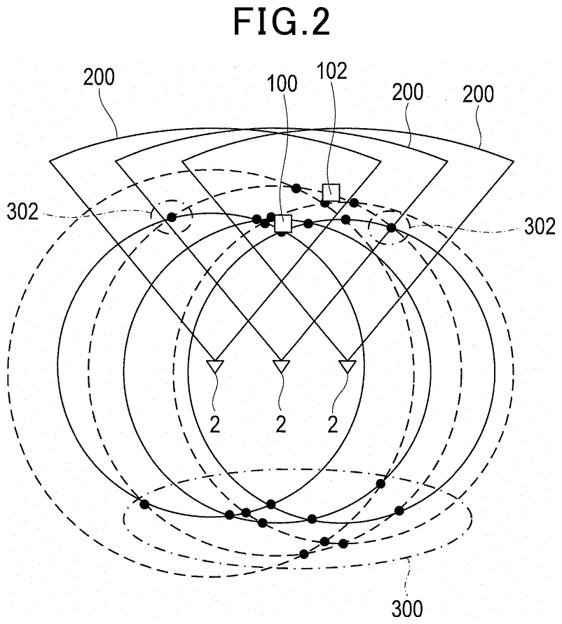

The result acquirer 12 acquires, as a measurement result, a distance and a speed of each object relative to each of the millimeter-wave radars 2. As illustrated in FIG. 2, the candidate-point extractor 14 extracts, as candidate points representing the object, intersections of circles centered at the respective ranging sensors, each with a radius equal to the distance to the object acquired from the millimeter-wave radars 2 by the result acquirer 12.

In FIG. 2, the solid-line circles are circles centered at the respective millimeter-wave radars 2, each with a radius equal to the distance to an object 100. The dotted-line circles are circles centered at the respective millimeter-wave radars 2, each with a radius equal to the distance to an object 102. The objects 100, 102 are indicated by the squares, and candidate points are indicated by the black spots.

The candidate points include candidate points 300, 302 surrounded by the dashed-dotted lines that represent virtual images of the objects 100, 102, which are different from actual objects 100, 102.

The density calculator 16 calculates a density of the candidate points based on the variance of the positions of the candidate points or the like. The candidate-point determiner 18 determines, for each of the candidate points, whether the candidate point is a real image or a virtual image, based on the detection ranges 200 of the millimeter-wave radars 2 and the density of the candidate points calculated by the density calculator 16. The detection range of each millimeter-wave radar 2 is set based on, for example, a mounting position and a mounting angle of the millimeter-wave radar 2.

The object detector 20 detects positions of the objects based on the positions of the candidate points each representing a real image, that is, the candidate points excluding the candidate points each determined by the candidate-point determiner 18 to be a virtual image.

1-2. Object Detection Process A process in which the object detection apparatus 10 detects an object from the candidate points will now be described.

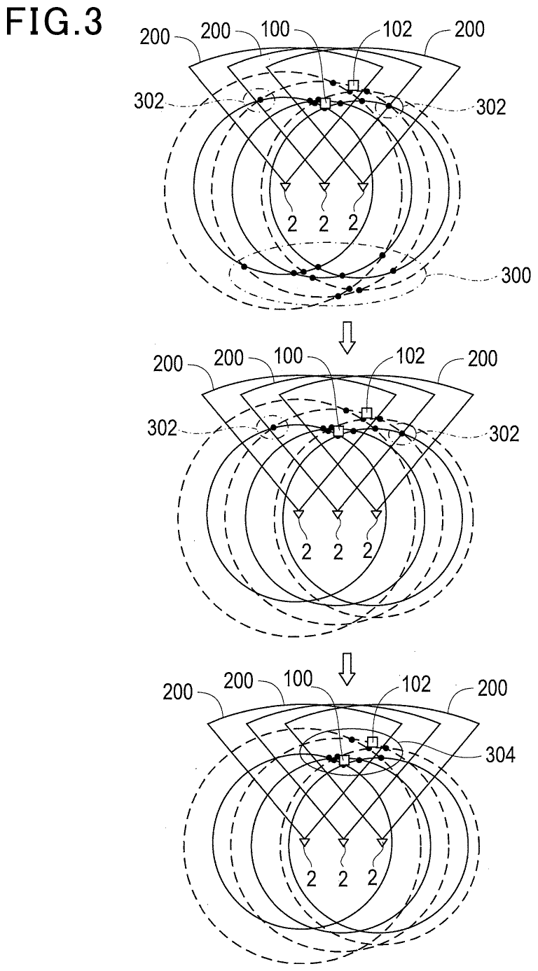

As illustrated in the middle part of FIG. 3, the candidate-point determiner 18 determines that the candidate points 300 outside the detection ranges 200 of the millimeter-wave radars 2 are virtual images, and removes them from the candidate points illustrated in the top part of FIG. 3.

As illustrated in the bottom part of FIG. 3, the candidate-point determiner 18 determines that the candidate points 302, each located away from the other candidate points with a low density of other candidate points therearound, are virtual images, and removes them from the candidate points illustrated in the middle part of FIG. 3. In the bottom part of FIG. 3, the candidate points 304 indicated by the black spots surrounded by the solid line are candidate points of real images after removal of the virtual images.

The object detector 20 detects positions of the actual objects 100 and 102 by calculating the centroid of positions of the candidate points 304 representing real images or by performing the detection process using the minimum square method based on distances of the candidate points 304, a clustering algorithm, such as the k-means method, or the like.

1-3. Advantages

In the first embodiment described above, intersections of circles centered at the respective ranging sensors, each with a radius equal to the distance to an object detected by the millimeter-wave radars 2 are extracted as candidate points representing the object. The candidate points 300 present outside the detection ranges 200 of the respective millimeter-wave radars 2 and the candidate points 302, each within at least one of the detection ranges 200 but with a low density of other candidate points therearound, are determines as virtual images and removed from the candidate points.

With this configuration, the detection process is performed not on all of the candidate points extracted as intersections of circles by the candidate-point extractor 14, but on the candidate points 304 representing real images acquired by removing the virtual images from the candidate points, which enables detection of positions of the objects 100 and 102. This can reduce the processing load and the processing time for detecting the objects.

In the above first embodiment, the millimeter-wave radars 2 correspond to ranging sensors.

### 2. SECOND EMBODIMENT

2-1. Differences from First Embodiment

A second embodiment is similar in basic configuration to the first embodiment. Thus, differences from the first embodiment will be described below. The same elements as in the first embodiment are assigned the same reference numbers and reference can be made to the preceding description.

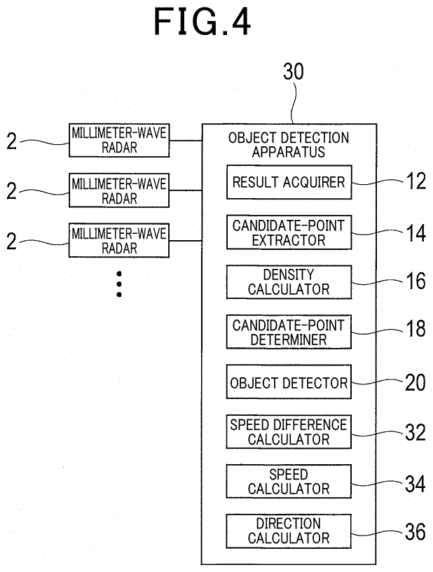

The object detection apparatus 30 illustrated in FIG. 4 is different from the detection apparatus 10 according to the first embodiment in that the object detection apparatus 30 includes not only the result acquirer 12, the candidate-point extractor 14, the density calculator 16, the candidate-point determiner 18, and the object detector 20, but also a speed difference calculator 32, a speed calculator 34, and a direction calculator 36.

The speed difference calculator 32 calculates, for each of the candidate points, a difference between relative speeds acquired from the plurality of millimeter-wave radar 2 by the result acquirer 12. The relative speed difference may be, for example, a difference between the maximum relative speed and the minimum relative speed.

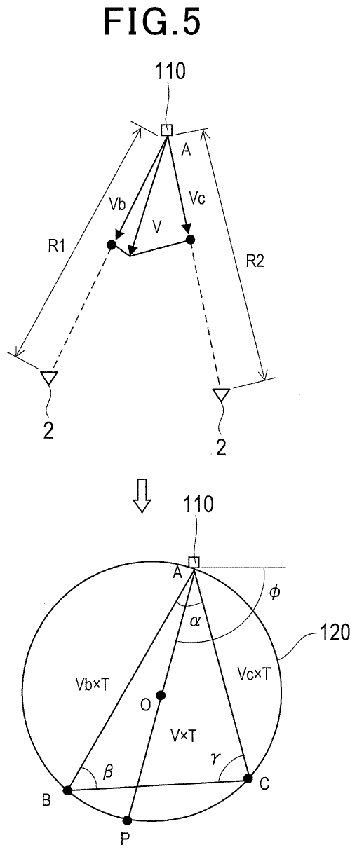

The speed calculator 34 calculates, for each of the candidate points, an absolute speed of the object represented by the candidate points based on the relative speeds acquired from the plurality of millimeter-wave radars 2 by the result acquirer 12. FIG. 5 illustrates an example where the speed calculator 34 calculates the absolute speed of the object.

In FIG. 5, one of the two millimeter-wave radars 2 detects a relative speed Vb of the object 110 indicated by the point A and a distance R1 to the object 110, and the other of the two millimeter-wave radars 2 detects a relative speed Vc of the object 110 and a distance R2 to the object 110. The relative speeds Vb and Vc of the object 110 detected by the respective millimeter-wave radars 2 are components of the relative speed V of the object 110 along the respective directions from the object 110 to the millimeter-wave radars 2.

The positions where the two millimeter-wave radars 2 are mounted to the vehicle are known. The position of the object 110 is represented by an intersection of circles centered at the respective ranging sensors, each with a radius equal to the distance to the object detected by a corresponding one of the millimeter-wave radars 2. In FIG. 5, the candidate point of a virtual image outside the detection ranges of the two millimeter-wave radars 2 has been removed.

The speed calculator 34 calculates a coordinate point B to which the object 110 will move at the relative speed Vb on a straight line connecting the point A and one of the millimeter-wave radars 2 after passage of a certain period of time (T) and a coordinate point C to which the object 110 will move at the relative speed Vc on a straight line connecting the point A and the other of the millimeter-wave radars 2 after passage of the certain period of time (T). The speed calculator 34 further calculates a coordinate point P to which the object 110 will move from the point A at the actual relative speed V after passage of the certain period of time (T).

Since the angle opposite the side AP of the triangle PBA and the angle opposite the side AP of the triangle PCA are right angles, the line segment AP is a diameter of the circumcircle 120 of the triangle ABC. Therefore, supposing that the angle opposite the side BC of the triangle ABC is α, the following equation (1) is derived from the sine formula.

AP=Vx T=BC/sin α (1)

In the above equation (1), T, coordinates of each of B and C, and a are known. Therefore, the speed calculator 34 can calculate, from the equation (1), the actual relative speed V of the object 100 to the vehicle. The speed calculator 34 calculates an absolute speed that is an actual speed of movement of the object 110, based on the relative speed V of the object 110 and the vehicle speed of the vehicle.

In FIG. 5, the speed calculator 34 calculates the relative speed V of the object 110 from results of measurement by the two millimeter-wave radars 2. Even in cases where the number of the millimeter-wave radars 2 is three or more, the speed calculator 34 may calculate, for example, the average of relative speeds calculated from respective pairs of millimeter-wave radars 2 as the relative speed of object 110.

The direction calculator 36 calculates, for each of the candidate points, a direction of movement of the candidate point based on the relative speed and the direction of the relative speed of the candidate point acquired by the result acquirer 12 from the plurality of millimeter-wave radars 2. An example of calculation of the direction of movement of the candidate point performed by the direction calculator 36 will now be described with reference to FIG. 5.

In FIG. 5, supposing that the angle opposite the side AC of the triangle ABC is β, the angle opposite the side AB of the triangle ABC is γ, a vector of the point A is a, a vector of the point B is b, a vector of the point C is c, and a vector of the center O of the circumcircle 120 is o, the following equation (2) is derived from the cosine formula and Heron's formula.

o=(α×sin 2α+b×sin 2β+c×sin 2γ)/(sin 2α+sin 2β+sin 2γ) (2)

In the equation (2), α, β, γ, a, b, c are all known. Therefore, the direction calculator 36 can calculate the vector o from the equation (2).

An angle of the direction of movement of the object 110, that is, the direction of a vector (o−a), relative to the lateral direction of the vehicle is represented by the angle φ as illustrated in FIG. 5. The direction calculator 36 calculates the angle φ from the following equation (3), where (ox, oy) represents coordinates of the vector o and (ax, ay) represents coordinates of the vector a.

φ=arctan((oy−ay)/(ox−ax)) (3)

In FIG. 5, the direction calculator 36 calculates the direction of movement of the object 110 from the results of measurement by the two millimeter-wave radars 2. Even in cases where the number of the millimeter-wave radars 2 is three or more, the direction calculator 36 may calculate, for example, the average of the directions of movement calculated from respective pairs of millimeter-wave radars 2 as the direction of movement of the object 110.

2-2. Object Detection Process

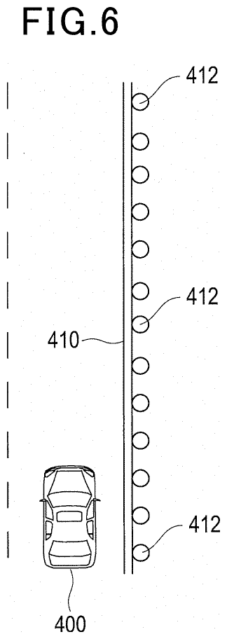

As illustrated in FIG. 6, the process performed by the object detection apparatus 30 to detect a guardrail 410 during traveling of the vehicle 400 on a road where a guardrail 410 is installed on its roadside will be described below.

In the second embodiment, a total of eight millimeter-wave radars 2 are mounted on the front, left and right sides of the vehicle 400. The millimeter-wave radars 2 detect guardrail posts 412 of the guardrail 410 as objects.

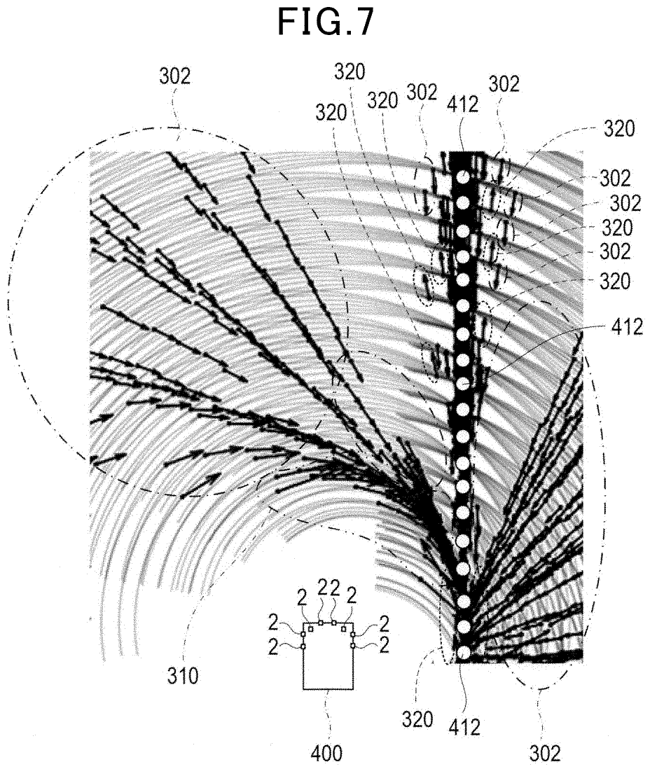

In FIG. 7, the start point of each arrow, that is, the root of each arrow, represents a candidate point of an object extracted based on the measured distance measured by the millimeter-wave radars 2. FIG. 7 illustrates the candidate points with virtual images not present in any one of the detection ranges of the millimeter-wave radars 2 removed by the point determiner 18.

The length of each arrow represents the magnitude of the speed of movement. As described above, the actual speed of movement of each object is calculated by the speed calculator 34. The direction of the arrow represents the actual direction of movement of the object. As described above, the direction of movement of the object is calculated by the direction calculator 36.

The candidate-point determiner 18 determines that the candidate points 302 surrounded by any one of the dashed-dotted lines, each located away from the other candidate points with a low density of other candidate points therearound, are virtual images, and removes the candidate points 302 from the candidate points.

The candidate-point determiner 18 determines, for each of the candidate points, that the candidate point is a virtual image if its relative speed difference calculated by the speed difference calculator 32 is greater than or equal to a predetermined value.

The predetermined value to be compared with the relative speed difference is set to a maximum value of relative speed difference arising from differences in mounting positions of the millimeter-wave radars 2 and measurement errors of the millimeter-wave radars 2. If a candidate point is a real image, the relative speed difference detected by the plurality of millimeter-wave radars 2 at this candidate point should be less than the predetermined value.

The candidate-point determiner 18 determines that a candidate point is a virtual image if the actual speed of movement of this candidate point is equal to or greater than a predetermined speed considered to be a speed of an object moving on a road.

The candidate-point determiner 18 removes the candidate points 310 surrounded by the chain double-dashed line from the candidate points, considering that each of the candidate points 310 has the relative speed difference equal to or greater than the predetermined value or the speed of movement equal to or greater than the predetermined speed.

The candidate-point determiner 18 removes the candidate points 320 each surrounded by the dotted line and having a movement direction less related to movement directions of other candidate points therearound, considering that these candidate points 320 are virtual images. A candidate point that is less related to movement directions of other candidate points therearound is, for example, a candidate point whose movement direction is opposite the movement directions of candidate points therearound.

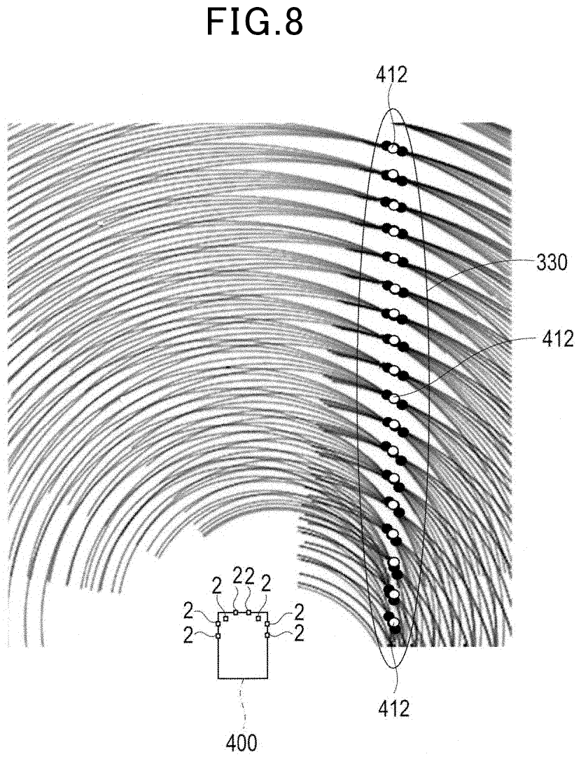

FIG. 8 illustrates the candidate points 330 indicated by the filled circles, surrounded by the solid line, after removal of virtual images by the candidate-point determiner 18. The object detector 20 performs the detection process described in the first embodiment on the candidate points 330 indicated by the filled circles to detect positions of the guardrail posts 412 of guardrail 410.

The guardrail 410 and the guardrail posts 412 in the second embodiment correspond to objects.

2-3. Advantages. The second embodiment set forth above can provide the following advantage in addition to the advantages of the first embodiment.

The candidate-point determiner 18 can more accurately determine which candidate point is a virtual image, based on calculated information not only from the density calculator 16, but also from the speed difference calculator 32, the speed calculator 34, and the direction calculator 36. This enables improvement of the detection accuracy of a position of an object.

### 3. OTHER EMBODIMENTS

While the embodiments of the present disclosure have been described above, the present disclosure is not limited to the above-described embodiments, and may incorporate various modifications.

(1) In the above embodiments, the millimeter-wave radars 2 are used as ranging sensors to measure a distance to an object. In an alternative embodiment, any other type of ranging sensor that can emit probe waves to measure a distance to an object, such as a sonar or the like, may be used.

(2) In an alternative embodiment, the object detection apparatus may be mounted to any other type of mobile object than the vehicle, such as a bicycle, a wheelchair, a robot or the like.

(3) In an alternative embodiment, the object detection apparatus may be installed in a fixed position on a stationary object or the like other than the mobile object.

(4) A plurality of functions of one component in the above-described embodiments may be realized by a plurality of components, or one function of one component may be realized by a plurality of components. Further, a plurality of functions of a plurality of components may be realized by one component, or one function to be realized by a plurality of components may be realized by one component. Still further, part of the components of the above-described embodiments may be omitted. In addition, at least part of the components of the above-described embodiments may be added to or replaced with the components in another embodiment. All modes contained in the technical ideas specified by the text only described in the scope of claims are the embodiments of the present disclosure.

(5) Besides the object detection apparatus 10, 30 described above, the present disclosure can be implemented in various modes such as a system including the object detection apparatus 10, 30 as a constituent element, an object detection program for causing a computer to serve as the object detection apparatus 10, 30, a storage medium storing this object detection program, an object detection method, and others.

What is claimed is:

1. An object detection apparatus for detecting a position of an object based on at least measured distances to the object as measurement results by a plurality of ranging sensors, each of the plurality of ranging sensors being a radar, the object detection apparatus comprising:
a result acquirer configured to acquire the measured distances and relative speeds of the object to the object detection apparatus as the measurement results from the plurality of ranging sensors;
a candidate-point extractor configured to extract candidate points representing the position of the object based on the measured distances to the object as the measurement results acquired by the result acquirer;
a speed difference calculator configured to calculate, for each of the candidate points extracted by the candidate-point extractor, a relative speed difference between the relative speeds of the candidate point acquired by the result acquirer from the plurality of ranging sensors,
a candidate-point determiner configured to determine that a candidate point, of the extracted candidate points, the calculated relative speed difference of which is equal to or greater than a predetermined value, is a virtual image of the object, and thereby determine, for each of the extracted candidate points, whether the candidate point is a real image or a virtual image of the object;
an object detector configured to detect the position of the object based on positions of the candidate points each determined by the candidate-point determiner to be a real image after removal of the candidate points each determined by the candidate-point determiner to be a virtual image from the candidate points extracted by the candidate-point extractor.

2. The object detection apparatus according to claim 1, wherein
the candidate-point determiner is configured to determine that a candidate point, of the candidate points extracted by the candidate-point extractor, which is not present in any one of detection ranges of the ranging sensors is a virtual image.

3. The object detection apparatus according to claim 1, wherein
the plurality of ranging sensors comprise three or more ranging sensors,
the object detection apparatus further comprises a density calculator configured to calculate a density of the candidate points represented by circle intersections at the measured distances to the object detected by the three or more ranging sensors, and
the candidate-point determiner is configured to determine, for each of the candidate points, whether the candidate point is a real image or a virtual image of the object, based on the density calculated by the density calculator.

4. The object detection apparatus according to claim 1, further comprising a speed calculator configured to calculate, for each of the candidate points, an absolute speed of the candidate point from the relative speeds acquired by the result acquirer from the plurality of ranging sensors,
the candidate-point determiner is configured to determine that a candidate point, of the candidate points extracted by the candidate-point extractor, the absolute speed of which calculated by the speed calculator is equal to or greater than a predetermined speed, is a virtual image of the object.

5. The object detection apparatus according to claim 1, further comprising a direction calculator configured to calculate, for each of the candidate points, a movement direction of the candidate point based on the relative speed and a direction of the relative speed acquired by the result acquirer from the plurality of ranging sensors,
wherein the candidate-point determiner is configured to determine that a candidate point, of the candidate points extracted by the candidate-point extractor, the movement direction of which is related to the movement directions of other candidate points therearound is a real image of the object and that a candidate point, of the candidate points extracted by the candidate-point extractor, the movement direction of which is less related to the movement directions of other candidate points therearound is, a virtual image of the object.

6. An object detection apparatus for detecting a position of an object based on at least measured distances to the object as measurement results by a plurality of ranging sensors, each of the plurality of ranging sensors being a radar, the object detection apparatus comprising:
a non-transitory memory storing one or more computer programs; and
a processor executing the one or more computer programs to:
extract candidate points representing the position of the object based on the measured distances to the object acquired from the plurality of ranging sensors as the measurement results;
acquire, for each of the extracted candidate points, relative speeds of the candidate point to the object detection apparatus from the plurality of ranging sensors as the measurement results;
calculate, for each of the extracted candidate points, a relative speed difference between the relative speeds of the candidate point acquired from the plurality of ranging sensors;
determine that a candidate point, of the extracted candidate points, the calculated relative speed difference of which is equal to or greater than a predetermined value, is a virtual image of the object, and thereby determine, for each of the extracted candidate points, whether the candidate point is a real image or a virtual image of the object; and
detect the position of the object based on positions of the candidate points each determined to be a real image after removal of the candidate points each determined to be a virtual image from all of the extracted candidate points.
